(19) United States
(12) Patent Application Publication
(10) Pub. No.: US 2023/0032031 A1
(43) Pub. Date: Feb. 2, 2023

(54) LINEAR REGULATOR CIRCUIT

(71) Applicant: ROHM Co., LTD., Kyoto (JP)

(72) Inventor: Hayato Asano, Kyoto (JP)

(21) Appl. No.: 17/814,875

(22) Filed: Jul. 26, 2022

(30) Foreign Application Priority Data
Jul. 27, 2021 (JP) 2021-122230

(51) Int. Cl. G05F 1/575; G05F 1/569

(52) U.S. Cl. CPC G05F 1/575; G05F 1/569

(57) ABSTRACT

Disclosed here is a linear regulator circuit including an input line, an output line, a P-channel output transistor connected between the input line and the output line, a feedback circuit that performs feedback control on a gate voltage of the output transistor such that an output voltage of the output line approaches a target level, and a protective circuit that clamps the gate voltage of the output transistor such that the gate voltage does not fall below a voltage level lower than the output voltage by a predetermined voltage.

### CROSS REFERENCE TO RELATED APPLICATIONS

This application claims priority benefit of Japanese Patent Application No. JP 2021-122230 filed in the Japan Patent Office on Jul. 27, 2021. Each of the above-referenced applications is hereby incorporated herein by reference in its entirety.

### BACKGROUND

The present disclosure relates to a linear regulator.

Various electronic circuits and electronic devices use a linear regulator circuit in order to generate a voltage that maintains a fixed voltage level without depending on a power supply voltage (input voltage).

An example of the related art is disclosed in Japanese Patent Laid-open No. 2007-157070.

### SUMMARY

Depending on uses, an input voltage V_{IN} of the linear regulator circuit may vary greatly. When the input voltage V_{IN} becomes lower than a target voltage level V_{OUT(REF)} of an output voltage V_{OUT}, a gate voltage V_{PG} of an output transistor of the linear regulator circuit is greatly lowered by feedback. At this time, the output transistor is fully on, and thus V_{OUT}=V_{IN}.

When the input voltage V_{IN} rises sharply to a voltage level higher than the target level V_{OUT(REF)} from this state while the output transistor is fully on, the output voltage V_{OUT} rises so as to follow the input voltage V_{IN}, so that an overshoot occurs.

The present disclosure has been made in view of such circumstances. As a certain example of the present disclosure, it is desirable to provide a linear regulator circuit that can suppress an overshoot.

A linear regulator circuit according to a certain example of the present disclosure includes an input line, an output line, a P-channel output transistor connected between the input line and the output line, a feedback circuit that performs feedback control on a gate voltage of the output transistor such that an output voltage of the output line approaches a target level, and a protective circuit that clamps the gate voltage of the output transistor such that the gate voltage does not fall below a voltage level lower than the output voltage by a predetermined voltage.

Another example of the present disclosure is also a linear regulator circuit. This linear regulator circuit includes an input line, an output line, a P-channel output transistor connected between the input line and the output line, a feedback circuit that performs feedback control on a gate voltage of the output transistor such that an output voltage of the output line approaches a target level, and a protective circuit that is connected between the output line and a gate of the output transistor, and conducts and supplies a current from the output line to the gate of the output transistor when a potential difference between the output voltage and the gate voltage exceeds a predetermined voltage.

It is to be noted that any combinations of the above constituent elements as well as examples obtained by mutually replacing constituent elements and expressions between a method, a device, a system, and the like are also effective as examples of the present invention. Further, the description of this section does not describe all of essential features of the present invention, and therefore, subcombinations of these features described can be the present invention.

According to a certain example of the present disclosure, an overshoot can be suppressed.

### BRIEF DESCRIPTION OF THE DRAWINGS

FIG. 1 is a circuit diagram of a linear regulator circuit according to an embodiment;

FIG. 2 is an operation waveform chart of a linear regulator circuit according to a comparative technology;

FIG. 3 is an operation waveform chart of the linear regulator circuit in FIG. 1;

FIG. 4 is a circuit diagram of a linear regulator circuit according to a first embodiment;

FIG. 5 is a circuit diagram of a linear regulator circuit according to a second embodiment;

FIG. 6 is a circuit diagram depicting a specific example of a configuration of the linear regulator circuit in FIG. 5;

FIG. 7 is a circuit diagram of a linear regulator circuit according to a third embodiment;

FIG. 8 is a circuit diagram of a linear regulator circuit according to a fourth embodiment; and

FIG. 9 is a circuit diagram depicting a modification of a protective circuit.

### DETAILED DESCRIPTION OF THE PREFERRED EMBODIMENTS

### Outline of Embodiments

An outline of a few illustrative embodiments of the present disclosure will be described. This outline describes, in a simplified manner, a few concepts of one or a plurality of embodiments as an introduction to the following detailed description for a purpose of basic understanding of the embodiments, and does not limit the scope of the invention or the disclosure. This outline is neither a comprehensive outline of all conceivable embodiments nor intended to identify important elements of all of the embodiments or to demarcate the scope of a part or all of examples. For convenience, “one embodiment” may be used to refer to one embodiment (an example or a modification) or a plurality of embodiments (examples or modifications) disclosed in the present specification.

A linear regulator circuit according to one embodiment includes an input line, an output line, a P-channel output transistor connected between the input line and the output line, a feedback circuit that performs feedback control on a gate voltage of the output transistor such that an output voltage of the output line approaches a target level, and a protective circuit that clamps the gate voltage of the output transistor such that the gate voltage does not fall below a voltage level lower than the output voltage by a predetermined voltage.

When an input voltage V_{IN} becomes lower than a target voltage level V_{OUT(REF)} of the output voltage V_{OUT}, the feedback circuit tries to lower the gate voltage V_{PG} of the output transistor of the linear regulator circuit. However, the gate voltage V_{PG} is clamped by the protective circuit so as not to fall below the voltage level (clamp level) lower than the output voltage V_{OUT} by the predetermined voltage Δ.

Supposing that V_{PG}=V_{OUT}−ΔV and V_{OUT}≈V_{IN} hold, a gate-to-source voltage V_{GS} of the output transistor is clamped at ΔV. Suppose that the input voltage V_{IN} sharply rises to a voltage level higher than the target level V_{OUT(REF)} from this state. Because the gate-to-source voltage V_{GS} of the output transistor is immediately previously clamped at ΔV, an overshoot of the output voltage V_{OUT} can be suppressed even when the input voltage V_{IN} rises.

In one embodiment, the protective circuit may be connected between the output line and a gate of the output transistor, and may conduct and supply a current from the output line to the gate of the output transistor when a potential difference between the output voltage and the gate voltage exceeds a predetermined voltage. According to this configuration, the current flowing from the output line via the protective circuit can raise the gate voltage of the output transistor. The output voltage does not change even when the current is supplied from a path other than the output line to the gate of the output transistor. However, in this configuration, the current flowing from the output line to the gate acts in a direction of decreasing the output voltage, and can therefore further suppress the overshoot.

A linear regulator circuit according to one embodiment includes an input line, an output line, a P-channel output transistor connected between the input line and the output line, a feedback circuit that performs feedback control on a gate voltage of the output transistor such that an output voltage of the output line approaches a target level, and a protective circuit that is connected between the output line and a gate of the output transistor, and conducts and supplies a current from the output line to the gate of the output transistor when a potential difference between the output voltage and the gate voltage exceeds a predetermined voltage.

In one embodiment, the protective circuit may include a gate element that conducts when a voltage across the gate element exceeds a threshold voltage.

In one embodiment, the gate element may include a P-channel transistor having a gate and a drain connected to each other.

In one embodiment, the protective circuit may include a current source that becomes active when a voltage across the current source exceeds a threshold voltage.

In one embodiment, the protective circuit may include a rectifying element that allows a flow of a current going from the output line to the gate of the output transistor, and interrupts an opposite current.

In one embodiment, the rectifying element may include a field-effect transistor having a gate and a source connected to each other.

In one embodiment, the rectifying element may include a diode.

In one embodiment, the protective circuit may include a switch that is off when the linear regulator circuit is disabled.

In one embodiment, the protective circuit may include a switch that is off when the gate voltage of the output transistor is higher than a predetermined threshold value.

In one embodiment, the linear regulator circuit may be integrated on one semiconductor substrate. “Integrated” includes a case where all of circuit constituent elements are formed on the semiconductor substrate and a case where main circuit constituent elements are integrated. A part of resistances, capacitors, and the like may be provided outside the semiconductor substrate for adjustment of circuit constants. Integrating the circuit on one chip can reduce a circuit area, and hold characteristics of the circuit elements uniform.

### Embodiment

A preferred embodiment will hereinafter be described with reference to the drawings. Identical or equivalent constituent elements, members, and processing depicted in each drawing are identified by the same reference numerals, and repeated description thereof will be omitted as appropriate. In addition, the embodiment is not restrictive of the invention but is illustrative, and all features described in the embodiment and combinations thereof are not necessarily essential to the invention.

In the present specification, a “state in which a member A is connected to a member B” includes a case where the member A and the member B are physically directly connected to each other and a case where the member A and the member B are indirectly connected to each other via another member that does not affect an electrically connected state or does not hamper functions.

Similarly, a “state in which a member C is provided between the member A and the member B” includes not only a case where the member A and the member C or the member B and the member C are directly connected to each other but also a case where the member A and the member C or the member B and the member C are indirectly connected to each other via another member that does not affect an electrically connected state or does not hamper functions.

In addition, a description that a “signal A (voltage or current) is according to a signal B (voltage or current)” means that the signal A has correlation to the signal B, and specifically means (i) a case where the signal A is the signal B, (ii) a case where the signal A is in proportion to the signal B, (iii) a case where the signal A is obtained by level-shifting the signal B, (iv) a case where the signal A is obtained by amplifying the signal B, (v) a case where the signal A is obtained by inverting the signal B, (vi) a freely selected combination thereof, or the like. It is understood by those skilled in the art that the scope of “according” is determined according to kinds and uses of the signals A and B.

Axes of ordinates and axes of abscissas in waveform charts and timing diagrams referred to in the present specification are enlarged or reduced as appropriate in order to facilitate understanding, and each waveform depicted therein is simplified or exaggerated or emphasized in order to facilitate understanding.

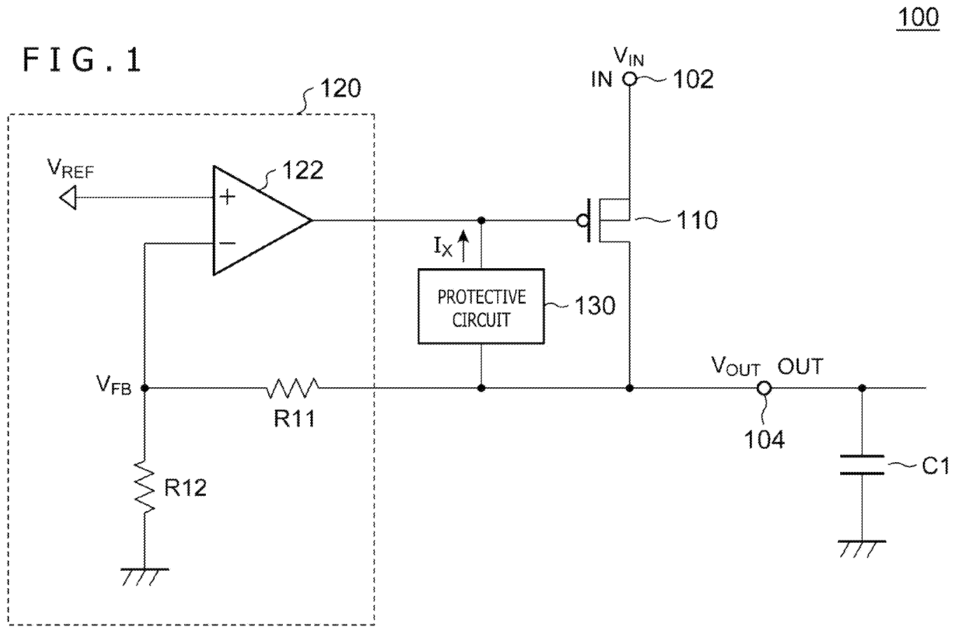

FIG. 1 is a circuit diagram of a linear regulator circuit 100 according to an embodiment. The linear regulator circuit 100 receives an input voltage V_{IN} at an input terminal IN (input line 102), generates an output voltage V_{OUT} stabilized at a predetermined target level V_{OUT(REF)}, and supplies the output voltage V_{OUT} to a load (not depicted) connected to an output terminal OUT (output line 104). The linear regulator circuit 100 is referred to also as a low drop output (LDO).

The linear regulator circuit 100 is integrated on one semiconductor substrate. The linear regulator circuit 100 may be an integrated circuit (IC) of the linear regulator circuit alone, or may be an internal power supply included in an IC having another function.

The linear regulator circuit 100 includes an output transistor 110, a feedback circuit 120, and a protective circuit 130. The output transistor 110 is a P-channel metal oxide semiconductor field effect transistor (MOSFET). The output transistor 110 has a source thereof connected to the input line 102, and has a drain thereof connected to the output line 104. In addition, an output capacitor C1 is connected to the output line 104.

The feedback circuit 120 performs feedback control on the gate voltage V_{PG} of the output transistor 110 such that the voltage of the output line 104 approaches a target level. For example, the feedback circuit 120 includes resistances R11 and R12 and an error amplifier 112. The resistances R11 and R12 generate a feedback voltage V_{FB} by voltage-dividing the output voltage V_{OUT}. The error amplifier 112 generates the gate voltage V_{PG} of the output transistor 110 by amplifying an error between the feedback voltage V_{FB} and a reference voltage V_{REF}. The feedback circuit 120 stabilizes the output voltage V_{OUT} at the target level V_{OUT(REF)} determined according to the reference voltage V_{REF}.

V_{OUT(REF)}=V_{REF}×(R11+R12)/R12

The protective circuit 130 clamps the gate voltage V_{PG} of the output transistor 110 such that the gate voltage V_{PG} does not fall below a voltage level (referred to as a clamp level) lower than the output voltage V_{OUT} occurring in the output line 104 by a predetermined voltage ΔV.

V_{CL}=V_{OUT}−ΔV

Preferably, the protective circuit 130 is connected between the output line 104 and the gate of the output transistor 110, and is configured to conduct and supply a current Ix from the output line 104 to the gate of the output transistor 110 when a potential difference between the output voltage V_{OUT} and the gate voltage V_{PG} exceeds the predetermined voltage ΔV.

The above is the configuration of the linear regulator circuit 100. Operation thereof will next be described. Advantages of the linear regulator circuit 100 are clarified by comparison with a comparative technology. Accordingly, a description will first be made of an overshoot occurring in a linear regulator circuit according to the comparative technology.

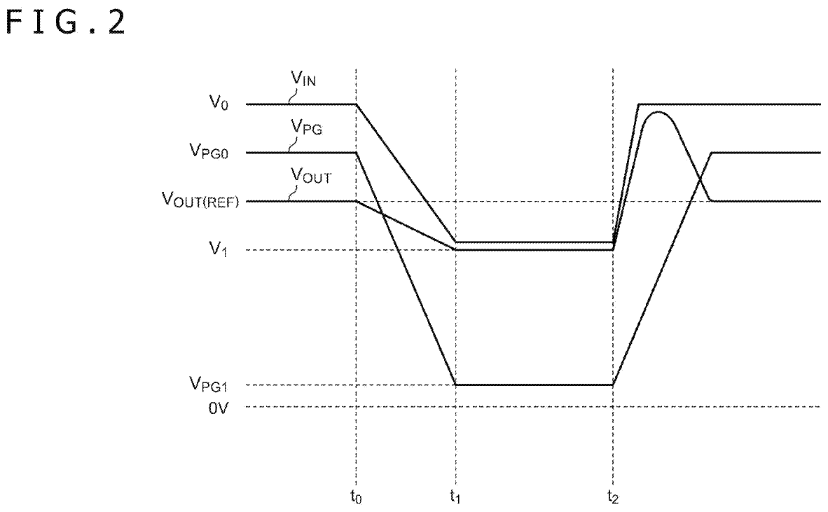

FIG. 2 is an operation waveform chart of a linear regulator circuit 100R according to the comparative technology. The linear regulator circuit 100R according to the comparative technology is obtained by omitting the protective circuit 130 from the linear regulator circuit 100 of FIG. 1.

Before time to, the input voltage V_{IN} has a voltage level V₀ higher than the target level V_{OUT(REF)} of the output voltage V_{OUT}. The gate voltage V_{PG} of the output transistor 110 at this time is a voltage level V_{PG0}.

For a period of time t₁ to t₂, the input voltage V_{IN} has a voltage level V₁ lower than the target level V_{OUT(REF)} of the output voltage V_{OUT}. At this time, due to feedback by the feedback circuit 120, the gate voltage V_{PG} of the output transistor 110 is lowered to a voltage level (0 V in the present example) V_{PG1} lower than the output voltage V_{OUT}, and the output transistor 110 is in a fully on state. The output voltage V_{OUT} assumes a voltage level close to the input voltage V_{IN} (=V₁).

Suppose that the input voltage V_{IN} rises sharply toward the original voltage level V₀ higher than the target level V_{OUT(REF)} of the output voltage V_{OUT} at time t₂. Due to a response delay of the feedback circuit 120, the gate voltage V_{PG} is delayed in changing from V_{PG1} to V_{PG0}. During this delay, the output transistor 110 is fully on, and therefore, a relation V_{OUT}≈V_{IN} holds. When the input voltage V_{IN} rises while the relation V_{OUT}≅V_{IN} is maintained, the output voltage V_{OUT} rises so as to follow the rise in the input voltage V_{IN}. Thereafter, due to feedback by the feedback circuit 120, when the gate voltage V_{PG} approaches V_{PG0}, the output voltage V_{OUT} approaches the target level V_{OUT(REF)}.

Thus, in the comparative technology, when the input voltage V_{IN} rises sharply, the output voltage V_{OUT} overshoots.

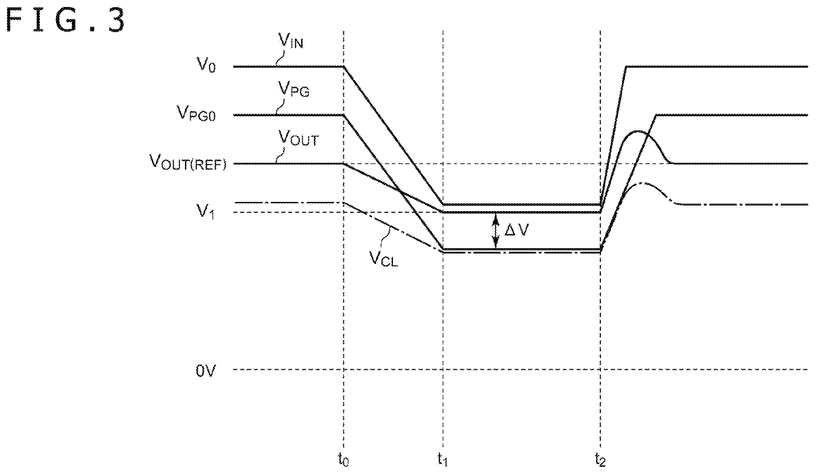

Operation of the linear regulator circuit 100 will next be described. FIG. 3 is an operation waveform chart of the linear regulator circuit 100 of FIG. 1.

A state before time to is similar to that of FIG. 2 (comparative technology). The input voltage V_{IN} has a voltage level V₀ higher than the target level V_{OUT(REF)} of the output voltage V_{OUT} The gate voltage V_{PG} of the output transistor 110 at this time is higher than a clamp level V_{CL} based on the output voltage V_{OUT}, and is therefore at the same voltage level V_{PG0} as in FIG. 2 without being affected by the protective circuit 130.

For a period of time t₁ to t₂, the input voltage V_{IN} has a voltage level V₁ lower than the target level V_{OUT(REF)} of the output voltage V_{OUT}. At this time, the feedback circuit 120 tries to lower the gate voltage V_{PG} to the voltage level V_{PG0} in FIG. 2. However, the protective circuit 130 conducts and supplies a current Ix from the output line 104 to the gate of the output transistor 110 when a potential difference V_{OUT}−V_{PG} between the output voltage V_{OUT} and the gate voltage V_{PG} exceeds a predetermined voltage ΔV. The supply of the current Ix raises the gate voltage V_{PG} of the output transistor 110, and holds the potential difference from the output voltage V_{OUT} fixed at ΔV. At this time, the gate voltage V_{PG} is clamped by the clamp level V_{CL}=V_{OUT}−ΔV. The gate-to-source voltage V_{GS} of the output transistor 110 in the period of time t₁ to t₂ is small as compared with that of the comparative technology (FIG. 2).

At time t₂, the input voltage V_{IN} rises sharply toward the original voltage level V₀ higher than the target level V_{OUT(REF)} of the output voltage V_{OUT} The gate-to-source voltage V_{GS} of the output transistor 110 at this time is small as compared with the comparative technology. Thus, even when the input voltage V_{IN} rises, an amount of increase in the output voltage V_{OUT} is suppressed as compared with the comparative technology. An overshoot can thereby be suppressed.

In addition, in the present embodiment, a time taken for the gate voltage V_{PG} to reach the voltage level V_{PG0} after time t₂ is shortened as compared with the comparative technology. An overshoot can be thereby suppressed.

In addition, the protective circuit 130 has a configuration for supplying the current Ix from the output line 104 to the gate of the output transistor 110. This current Ix is supplied from the output capacitor C1. Thus, the current Ix decreases the output voltage V_{OUT}, or acts also in a direction of suppressing an overshoot of the output voltage V_{OUT} Hence, the effect of overshoot suppression is stronger than a case where the current Ix for raising the gate voltage V_{PG} is supplied from a part (for example, the input line 102) other than the output line 104.

Operation of the linear regulator circuit 100 has been described above.

The present disclosure covers various devices and methods grasped as the block diagram or circuit diagram of FIG. 1 or derived from the above description, and is not limited to a specific configuration. In the following, more specific configuration examples and embodiments will be described not to narrow the scope of the present disclosure but to facilitate understanding of essences and operation of the present disclosure or the present invention and clarify the essences and operation of the present disclosure or the present invention.

### First Embodiment

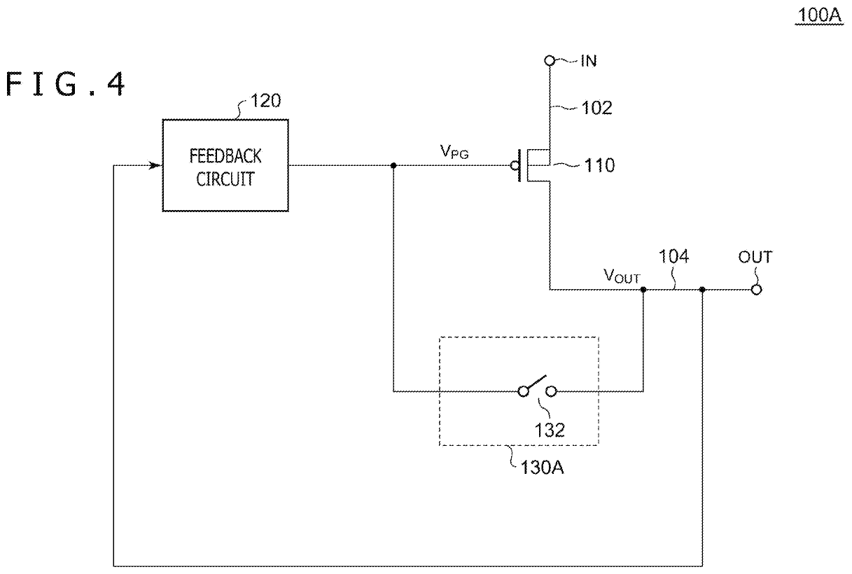

FIG. 4 is a circuit diagram of a linear regulator circuit 100A according to a first embodiment. A protective circuit 130A includes a gate element 132. The gate element 132 is in a shut-off state when a voltage across the gate element 132 is smaller than the threshold voltage V_{TH} The gate element 132 conducts when the voltage across the gate element 132 exceeds the threshold voltage V_{TH}. The threshold voltage V_{TH} is set according to ΔV. When the gate element 132 conducts, the current Ix flows from the output line 104 to the gate of the output transistor 110, and the gate voltage V_{PG} is clamped.

### Second Embodiment

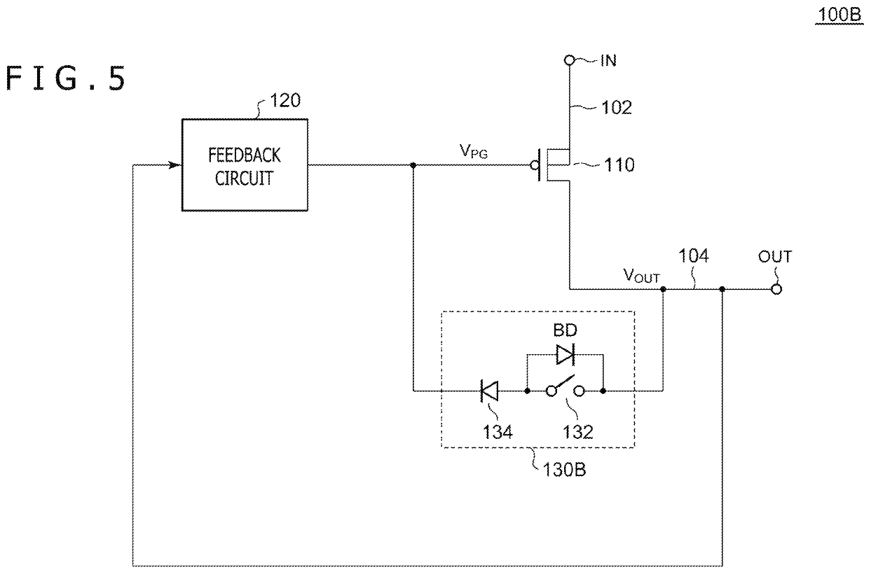

FIG. 5 is a circuit diagram of a linear regulator circuit 100B according to a second embodiment. A protective circuit 130B includes a rectifying element 134 in addition to the gate element 132. When the gate element 132 is formed by using a MOSFET or the like, the gate element 132 is in a state of conducting in an opposite direction at all times because of the presence of a body diode (parasitic diode) BD. Hence, in a state in which the gate voltage V_{PG} of the output transistor 110 is higher than the output voltage V_{OUT}, a current flows from the gate of the output transistor 110 to the output line 104, which is not desirable.

In addition, there is a possibility of the body diode BD of the gate element 132 generating a non-zero output voltage V_{OUT} in the output line 104 while the linear regulator circuit 100B is stopped.

The rectifying element 134 is provided to eliminate the effects of the body diode BD of the gate element 132. The rectifying element 134 allows a flow of the current Ix going from the output line 104 to the gate of the output transistor 110, and interrupts an opposite current.

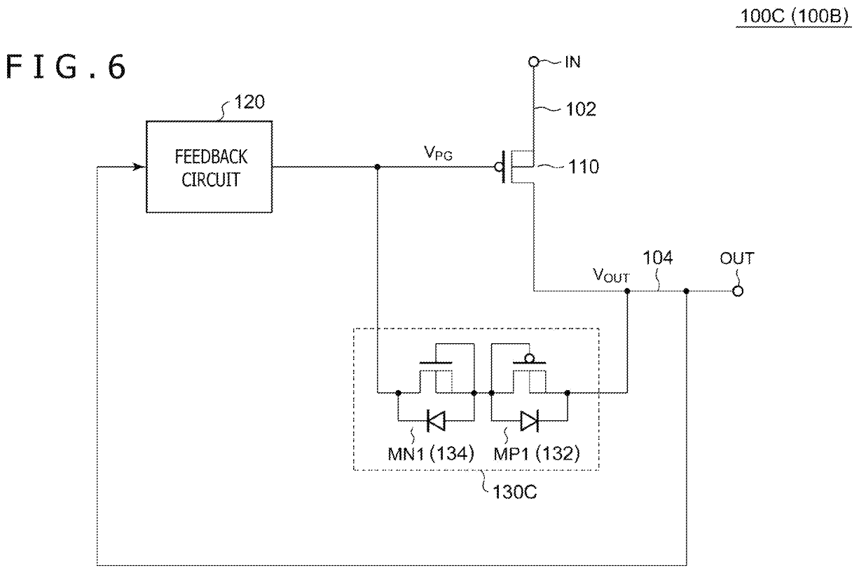

FIG. 6 is a circuit diagram depicting a specific example of a configuration (100C) of the linear regulator circuit 100B in FIG. 5. A protective circuit 130C includes a P-channel transistor MP1 corresponding to the gate element 132 and an N-channel transistor MN1 corresponding to the rectifying element 134.

The source of the P-channel transistor MP1 is connected to the output line 104. The gate and drain of the P-channel transistor MP1 are connected to each other. When a voltage across the P-channel transistor MP1 (drain-to-source voltage) becomes higher than a gate threshold value Vt of the P-channel transistor MP1, the P-channel transistor MP1 is turned on, and the current Ix flows.

The P-channel transistor MP1 can conduct in an opposite direction at all times due to the body diode of the P-channel transistor MP1.

The source of the N-channel transistor MN1 is connected to the drain of the P-channel transistor MP1. The drain of the N-channel transistor MN1 is connected to the gate of the output transistor 110. The gate and source of the N-channel transistor MN1 are connected to each other. Hence, the channel of the N-channel transistor MN1 is shut off at all times, and does not contribute to the operation of the protective circuit 130C. The body diode of the N-channel transistor MN1 interrupts the current going from the gate of the output transistor 110 to the output line 104.

The protective circuit 130C conducts, and the current Ix flows when a potential difference between the output voltage V_{OUT} and the gate voltage V_{PG} exceeds ΔV defined by Vf+Vt, where Vf is a forward voltage of the body diode of the transistor MN1, and Vt is the threshold voltage of the P-channel transistor MP1.

### Third Embodiment

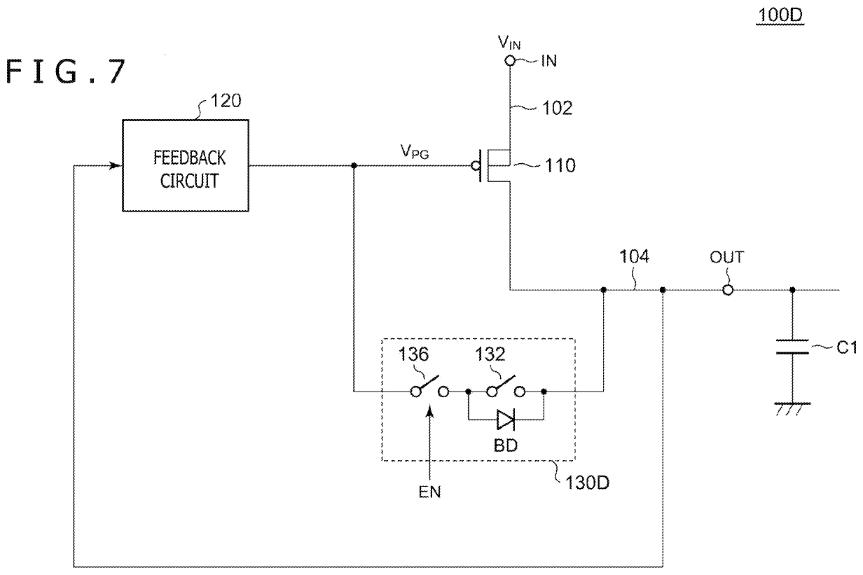

FIG. 7 is a circuit diagram of a linear regulator circuit 100D according to a third embodiment. A protective circuit 130D includes a switch 136 in place of the rectifying element 134 in FIG. 5. An enable signal EN of the linear regulator circuit 100D is input to the switch 136. The switch 136 is on during operation of the linear regulator circuit 100D. While the linear regulator circuit 100D is stopped, the switch 136 is off, and therefore, the occurrence of a nonzero output voltage V_{OUT} in the output line 104 can be prevented.

### Fourth Embodiment

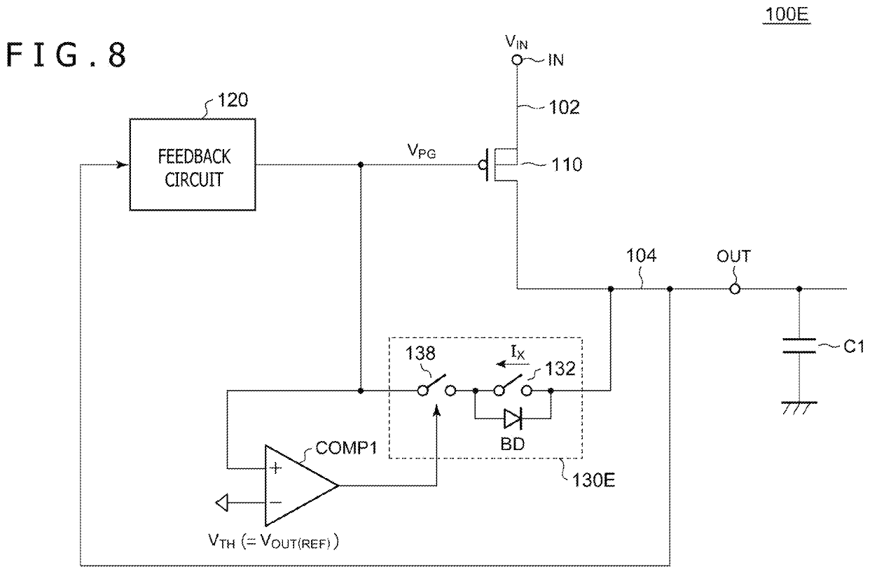

FIG. 8 is a circuit diagram of a linear regulator circuit 100E according to a fourth embodiment. A protective circuit 130E includes a switch 138. A reverse current flows in the protective circuit 130D when V_{PG}>V_{OUT}, that is, when V_{PG}>V_{OUT(REF)}. A comparator COMP1 compares the gate voltage V_{PG} with the threshold voltage V_{TH}. The comparator COMP1 turns off the switch 138 when V_{PG}>V_{TH}, and turns on the switch 138 when V_{PG}<V_{TH}. It suffices to define the threshold value V_{TH} according to the target level V_{OUT(REF)} of the output voltage V_{OUT}.

### Modifications

The foregoing embodiments are illustrative, and it is understood by those skilled in the art that combinations of constituent elements and processes of those embodiments are susceptible of various modifications. Such modifications will be described in the following.

### (First Modification)

With regard to the protective circuit 130, the positions of the gate element 132 and the rectifying element 134 may be interchanged. In addition, in FIG. 6, the gate element 132 may be formed by an N-channel transistor, and the rectifying element 134 may be formed by a P-channel transistor.

### (Second Modification)

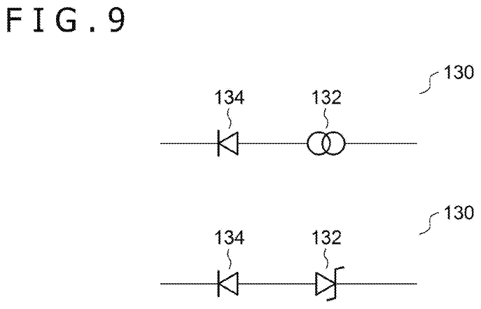

The gate element 132 is not limited to a MOS transistor. FIG. 9 is a circuit diagram depicting modifications of the protective circuit 130. The gate element 132 may, for example, be a current source that becomes active and generates the current Ix when a voltage across the current source exceeds a threshold value. Alternatively, the gate element 132 may be a Zener diode ZD1. In addition, the gate element 132 may be a diode formed by using a bipolar transistor.

The embodiments are illustrative, and it is to be understood by those skilled in the art that there are various modifications of combinations of constituent elements and processes of those embodiments and that such modifications are also included in the scope of the present disclosure or the present invention.

What is claimed is:

1. A linear regulator circuit comprising:
an input line;
an output line;
a P-channel output transistor connected between the input line and the output line;
a feedback circuit that performs feedback control on a gate voltage of the output transistor such that an output voltage of the output line approaches a target level; and
a protective circuit that clamps the gate voltage of the output transistor such that the gate voltage does not fall below a voltage level lower than the output voltage by a predetermined voltage.

2. The linear regulator circuit according to claim 1, wherein
the protective circuit is connected between the output line and a gate of the output transistor, and conducts and supplies a current from the output line to the gate of the output transistor when a potential difference between the output voltage and the gate voltage exceeds the predetermined voltage.

3. A linear regulator circuit comprising:
an input line;
an output line;
a P-channel output transistor connected between the input line and the output line;
a feedback circuit that performs feedback control on a gate voltage of the output transistor such that an output voltage of the output line approaches a target level; and
a protective circuit that is connected between the output line and a gate of the output transistor, and conducts and supplies a current from the output line to the gate of the output transistor when a potential difference between the output voltage and the gate voltage exceeds a predetermined voltage.

4. The linear regulator circuit according to claim 1, wherein
the protective circuit includes a gate element that conducts when a voltage across the gate element exceeds a threshold voltage.

5. The linear regulator circuit according to claim 4, wherein
the gate element includes a P-channel transistor having a gate and a drain connected to each other.

6. The linear regulator circuit according to claim 1, wherein
the protective circuit includes a current source that becomes active when a voltage across the current source exceeds a threshold voltage.

7. The linear regulator circuit according to claim 1, wherein
the protective circuit includes a rectifying element that allows a flow of a current going from the output line to the gate of the output transistor, and interrupts an opposite current.

8. The linear regulator circuit according to claim 7, wherein
the rectifying element includes a field-effect transistor having a gate and a source connected to each other.

9. The linear regulator circuit according to claim 7, wherein
the rectifying element includes a diode.

10. The linear regulator circuit according to claim 1, wherein
the protective circuit includes a switch that is off when the linear regulator circuit is disabled.

11. The linear regulator circuit according to claim 1, wherein
the protective circuit includes a switch that is off when the gate voltage of the output transistor is higher than a predetermined threshold value.

12. The linear regulator circuit according to claim 1, wherein
the linear regulator circuit is integrated on one semiconductor substrate.

13. The linear regulator circuit according to claim 3, wherein
the protective circuit includes a gate element that conducts when a voltage across the gate element exceeds a threshold voltage.

14. The linear regulator circuit according to claim 3, wherein
the protective circuit includes a current source that becomes active when a voltage across the current source exceeds a threshold voltage.

15. The linear regulator circuit according to claim 3, wherein
the protective circuit includes a rectifying element that allows a flow of a current going from the output line to the gate of the output transistor, and interrupts an opposite current.

16. The linear regulator circuit according to claim 3, wherein
the rectifying element includes a field-effect transistor having a gate and a source connected to each other.

17. The linear regulator circuit according to claim 3, wherein
the rectifying element includes a diode.

18. The linear regulator circuit according to claim 3, wherein
the protective circuit includes a switch that is off when the linear regulator circuit is disabled.

19. The linear regulator circuit according to claim 3, wherein
the protective circuit includes a switch that is off when the gate voltage of the output transistor is higher than a predetermined threshold value.

20. The linear regulator circuit according to claim 3, wherein
the linear regulator circuit is integrated on one semiconductor substrate.
